(19) United States
(12) Patent Application Publication
(10) Pub. No.: US 2025/0189304 A1
(43) Pub. Date: Jun. 12, 2025

(54) NON-CONTACT OPTIC PROBE FOR ENHANCING MEASUREMENT OF BACK DRILLING PROFILE DEPTH

(71) Applicant: CIN PHOWN TECHNOLOGY CO., LTD., Taoyuan City (TW)

(72) Inventors: FENG-CHIEH LI, Taoyuan City (TW); WEI-CHIH WANG, Taoyuan City (TW)

(21) Appl. No.: 18/537,710

(22) Filed: Dec. 12, 2023

(51) Int. Cl. G01B 11/22; G01B 11/06; G01B 11/24

(52) U.S. Cl. CPC G01B 11/22; G01B 11/06; G01B 11/24

(57) ABSTRACT

A non-contact optic probe for enhancing measurement of back drilling profile depth is provided, including a retaining device connected with a first moving module that includes a first power source and a reflection fixture on which a board having a first drilled hole is positioned; an optic probe bod arranged above the retaining device; and a compute is electrically connected with the optic probe body and the first moving module and includes an output unit. The computer activates the optic probe body to emit a light beam that has a diameter that is smaller than a radius of the first drilled hole to irradiate the board, and the computer controls the first power source to drive the retaining device to move so as to have the first drilled hole pass under the optic probe body to generate first reflection points that form a first drilled hole depth plane chart.

### BACKGROUND OF THE INVENTION

### (a) Technical Field of the Invention

The present invention relates to a circuit board back drill hole inspection device, and more particularly to a non-contact optic probe for enhancing measurement of back drilling profile depth that measures a thickness of a printed circuit board (PCB) and depth and eccentricity of drilled holes in a non-contact manner.

### (b) Description of the Prior Art

A known way of inspecting back drill holes adopts a destructive process, in which a circuit board is randomly selected and is cut into pieces to observe if each of the back drill holes meets the requirements. However, destructive inspection is time consuming and the known way suffers a major shortcoming that observation can only be made at specific angles. Thus, it is necessary to make further improvement.

### SUMMARY OF THE INVENTION

The primary objective of the present invention is to provide a non-contact optic probe for enhancing measurement of back drilling profile depth, which comprises: a retaining device, which is connected with a first moving module, the first moving module comprising a first power source, the retaining device comprising a reflection fixture, the reflection fixture having a top surface on which at least one board is positionable, the board being formed with at least one first drilled hole; at least one optic probe body, which is arranged above the retaining device; and a computer, which is electrically connected with the optic probe body and the first moving module, the computer comprising an output unit, wherein the computer is operable to activate the optic probe body to emit a light beam, the light beam having a diameter that is smaller than a radius of the first drilled hole, the light beam irradiating the board, and meanwhile, the computer controls the first power source to drive the retaining device to move so as to have the first drilled hole pass under the optic probe body, the first drilled hole being continuously irradiated with the light beam, and the computer records a plurality of first reflection points from entry of the light beam into the first drilled hole and the reflection fixture to exit therefrom, and generates a first drilled hole depth plane chart according to each of the first reflection points, and outputs the first drilled hole depth plane chart by means of the output unit.

### BRIEF DESCRIPTION OF THE DRAWINGS

FIG. 1 is a schematic view showing a structure of the present invention.

FIG. 2 is a side elevational view of a board according to the present invention.

FIG. 3 is a schematic view showing an architecture of a computer according to the present invention.

FIG. 4 is a schematic view showing a state of use of the present invention.

FIG. 5 is a schematic view, succeeding from FIG. 4, showing a first drilled hole irradiated with a light beam.

FIG. 6 is a schematic view showing calculation performed with the computer according to the present invention.

FIG. 7 is a schematic view showing a first drilled hole and second drilled hole depth plane chart according to the present invention.

FIG. 8 is a schematic view showing a first drilled hole depth plane chart from FIG. 6.

FIG. 9 is a schematic view showing a second drilled hole irradiated with a light beam from FIG. 4.

FIG. 10 is a schematic view showing a first drilled hole and second drilled hole depth plane chart according the present invention, with a reflection fixture being not used.

FIG. 11 is a schematic view showing setting of a moving path by the computer according to the present invention.

FIG. 12 is a schematic view showing a structure of another embodiment of the present invention.

### DETAILED DESCRIPTION OF THE PREFERRED EMBODIMENTS

A retaining device 10 is connected with a first moving module 11. The first moving module comprises a first power source 12. The retaining device 10 comprises a reflection fixture 101, and the reflection fixture 101 has a top surface on which at least one board A is positioned and clamped. The board A is formed with at least one first drilled hole A1, wherein the board has a predetermined thickness.

At least one optic probe body 20 is arranged above the retaining device 10.

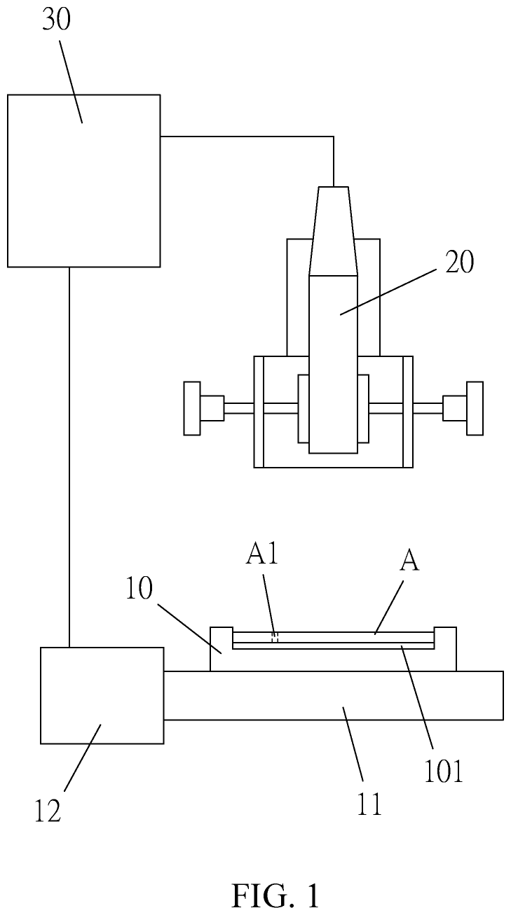

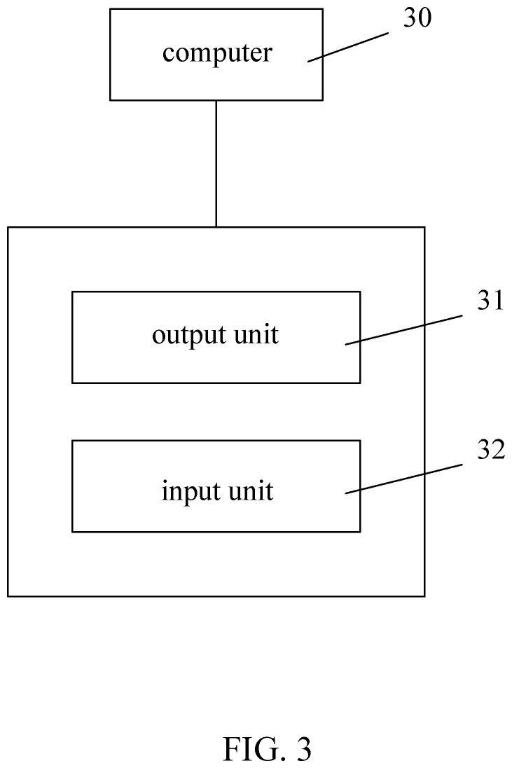

Referring to FIGS. 1 and 3, a computer 30 is electrically connected with the optic probe body 20 and the first power source 12 of the first moving module 11. The computer 30 comprises an output unit 31, and the output unit 31 comprises a display and a printer.

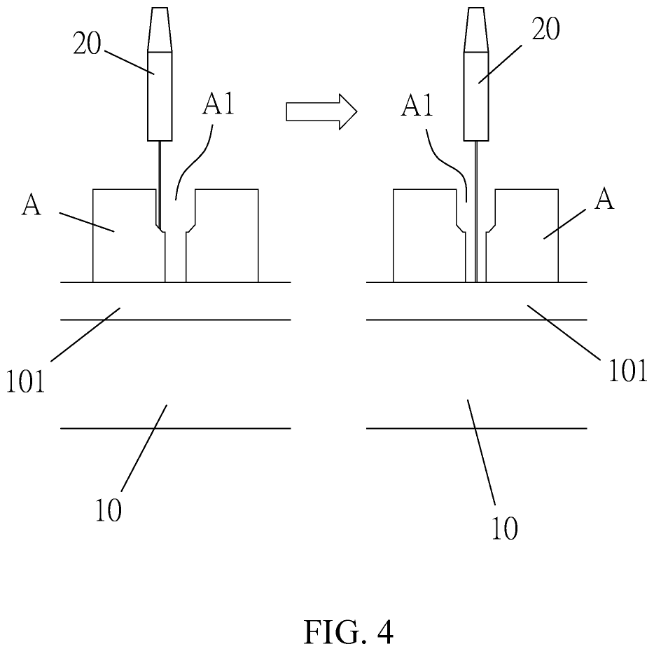

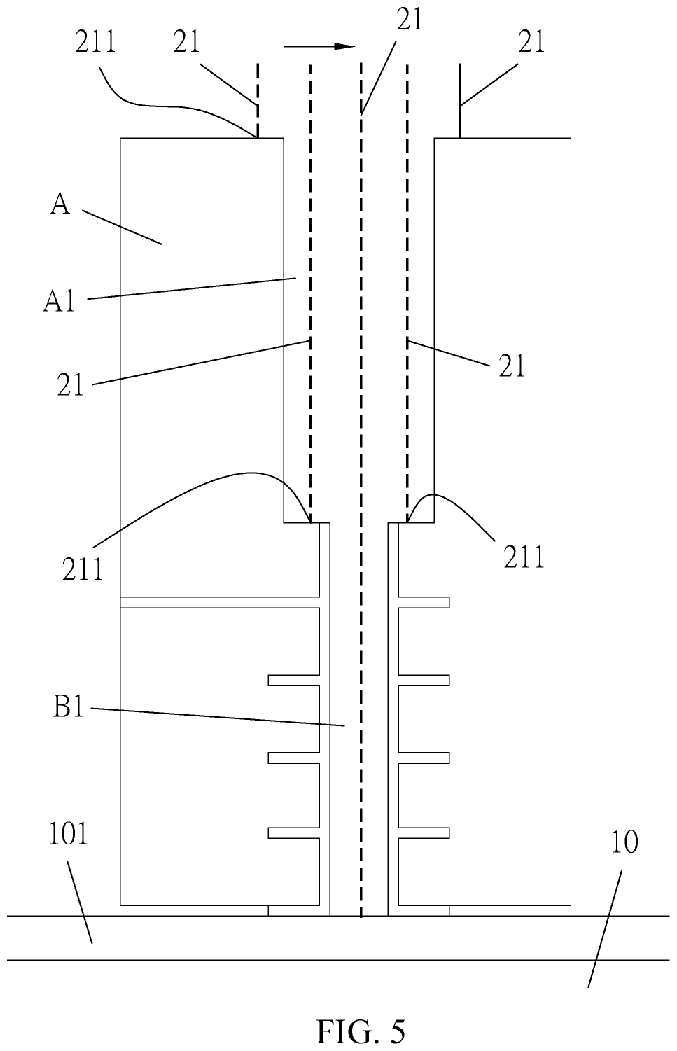

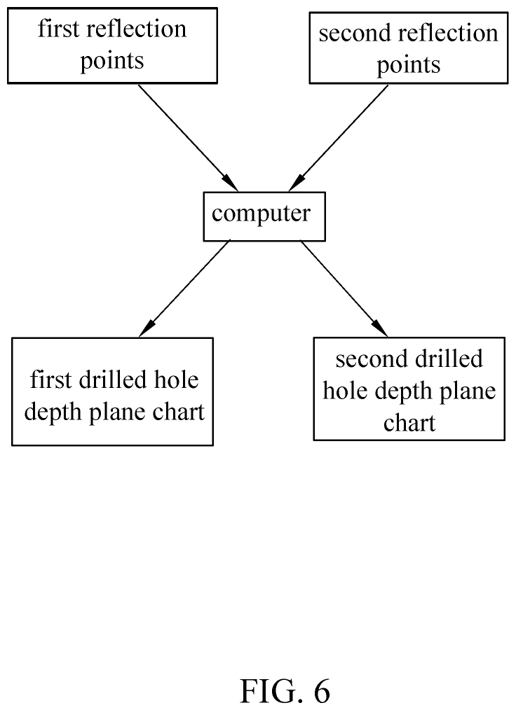

Referring to FIGS. 4 and 5, operation of the present invention is such that the computer 30 activates the optic probe body 20 to emit a light beam 21, wherein a diameter of the light beam 21 is smaller than a radius of the first drilled hole A1 (but not limited thereto), and the light beam 21 irradiates the board A, and meanwhile, the computer 30 controls the first power source 12 to drive the retaining device 10 to move so as to have the first drilled hole A1 passing under the optic probe body 20. Referring to FIGS. 5-7, the first drilled hole A1 is continuously irradiated with the light beam 21, and the computer 30 records a plurality of first reflection points 211 from entry of the light beam 21 into the first drilled hole A1 and the reflection fixture 101 to exit therefrom and generates a first drilled hole depth plane chart 40 according to each of the first reflection points 211, and outputs the first drilled hole depth plane chart 40 by means of the output unit 31.

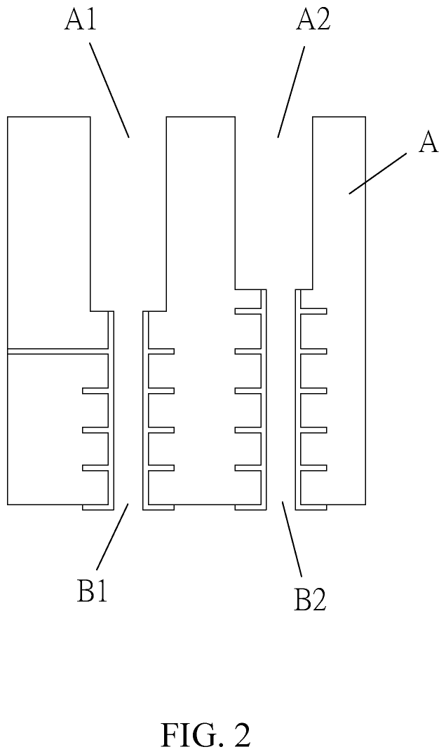

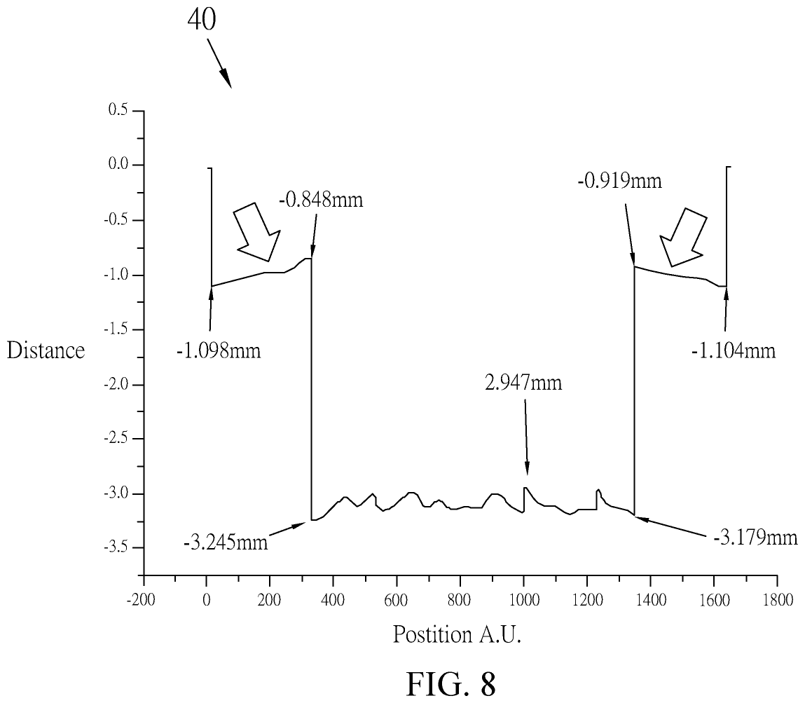

Referring to FIGS. 2 and 8, the board A is further formed with at least one second drilled hole A2, and a predetermined distance is formed between the second drilled hole A2 and the first drilled hole A1. After the first drilled hole A1 passes under the optic probe body 20, the computer 30 controls the first power source 12 to drive the retaining device 10 to move so as to have the second drilled hole A2 passing under the optic probe body 20. The second drilled hole A2 is continuously irradiated with the light beam 21, and the computer 30 records a plurality of second reflection points 212 from entry of the light beam 21 into the second drilled hole A2 and the reflection fixture 101 to exit thereof and generates a second drilled hole depth plane chart 50 according to each of the second reflection points 212, and outputs the second drilled hole depth plane chart 50 by means of the output unit 31.

In brief, through setting by means of the computer 30, the present invention enables quick inspection of a plurality of drilled holes, and after the inspection, each board A maintains an intact condition, and this overcomes the shortcoming of destructive inspection implemented in the prior art.

Referring to FIG. 2, in detail, the board A comprises at least one first penetration hole B1 and at least one second penetration hole B2. The first drilled hole A1 and the second drilled hole A2 are respectively drilled in the first penetration hole B1 and the second penetration hole B2, so that the first drilled hole A1 and the second drilled hole A2 are respectively coincident with the first penetration hole B1 and the second penetration hole B2, and the first drilled hole A1 and the second drilled hole A2 are respectively greater, in respect of diameter, than the first penetration hole B1 and the second penetration hole B2.

Referring to FIGS. 5-8, each individual one of the first reflection points 211 and each of the second reflection points 212 indicates a position where the light beam irradiates a surface of the board A, an interior of the first drilled hole A1, and an interior of the second drilled hole A2 and is blocked to have the light beam reflected back to the optic probe body 20. The computer 30 records and calculates the position and distance of each of the first reflection points 211 and the position and distance of each of the second reflection points 212 and respectively interconnects each of the first reflection points 211 and each of the second reflection points 212 to form the first drilled hole depth plane chart 40 and the second drilled hole depth plane chart 50.

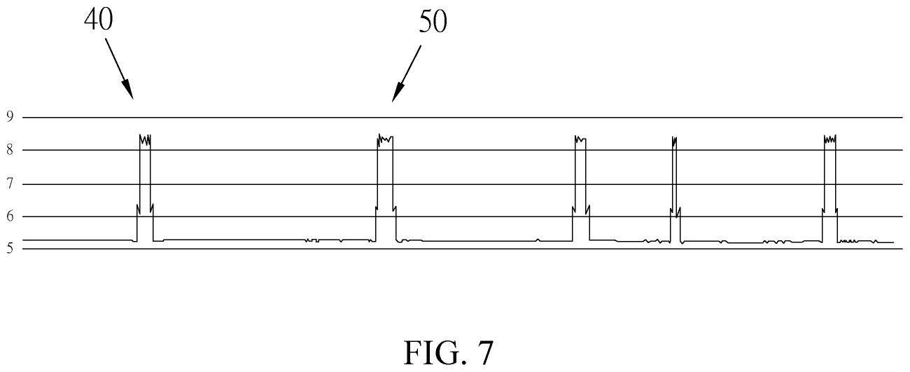

Referring to FIGS. 7 and 8, the first drilled hole depth plane chart 40 and the second drilled hole depth plane chart 50 are applied for inspection of a thickness of the board A, depths of the first drilled hole A1 and the second drilled hole A2, eccentricity of the first drilled hole A1 and the first penetration hole B1, and eccentricity of the second drilled hole A2 and the second penetration hole B2. Eccentricity is defined as a distance between the circle center of the first penetration hole Bland the circle center of the first drilled hole A1, or a distance between the circle center of the second penetration hole B2 and the circle center of the second drilled hole A2.

The cause for generating eccentricity is that, in the course of hole drilling, the drill bit is not set to correspond to the circle center of the penetration hole, or a situation of oscillation of the drill bit occurs in the course of hole drilling. And, practically, the eccentricity is hard to identify by bare eyes, and the present invention uses the first drilled hole depth plane chart 40 and the second drilled hole depth plane chart 50 to achieve easy analysis of the first drilled hole A1 and the second drilled hole A2.

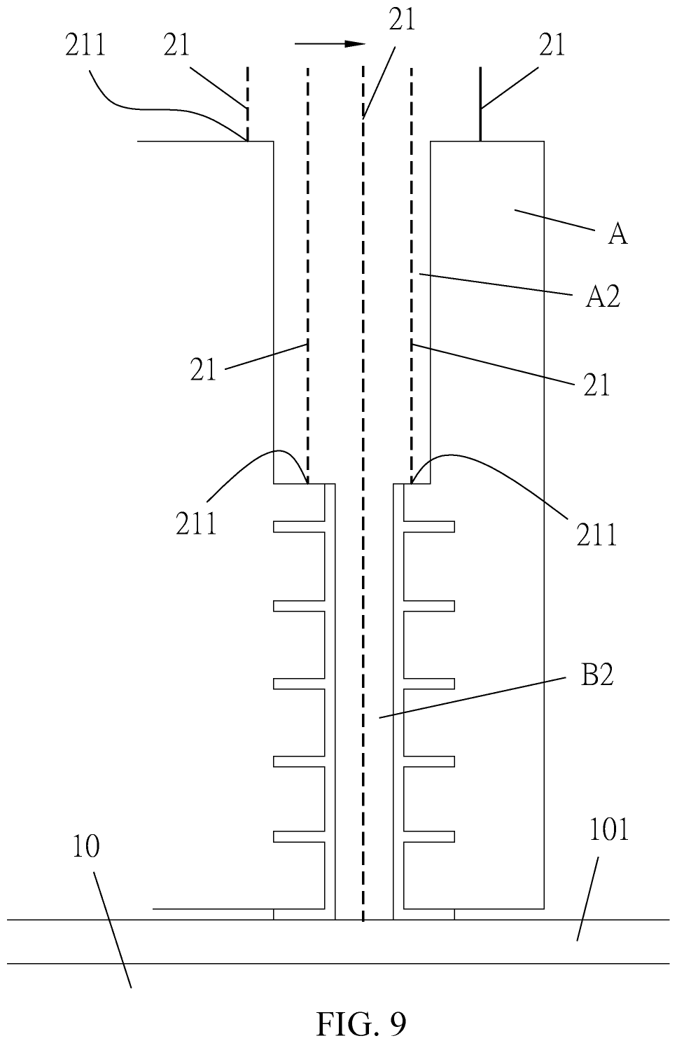

In FIGS. 2 and 9 of the present invention, the second drilled hole A2 and the second penetration hole B2 are purposely drawn in an eccentric condition in order to show the function of the present invention for inspecting eccentricity.

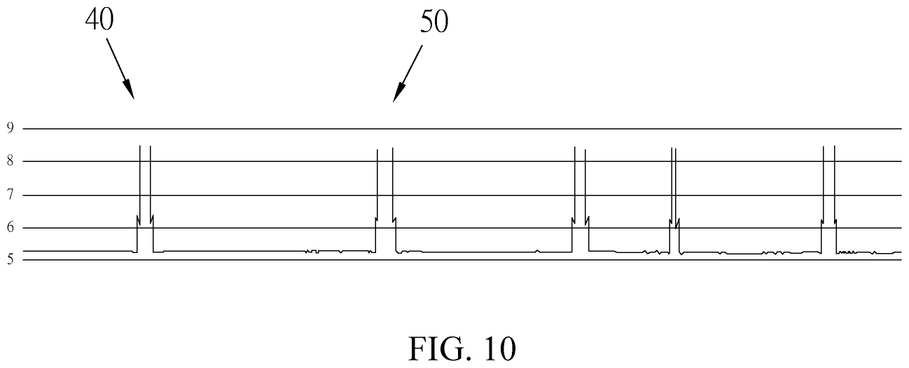

Referring to FIG. 10, since the board A has a predetermined thickness, if the reflection fixture 101 is not adopted, then the light beam 21 cannot be detected, and consequently, the first drilled hole depth plane chart 40 and the second drilled hole depth plane chart 50 provided by the computer 30 cannot present complete graphs of the first penetration hole B1 and the second penetration hole B2. And, as such, the reflection fixture 101 is necessarily included in order to reflect the light beam 21.

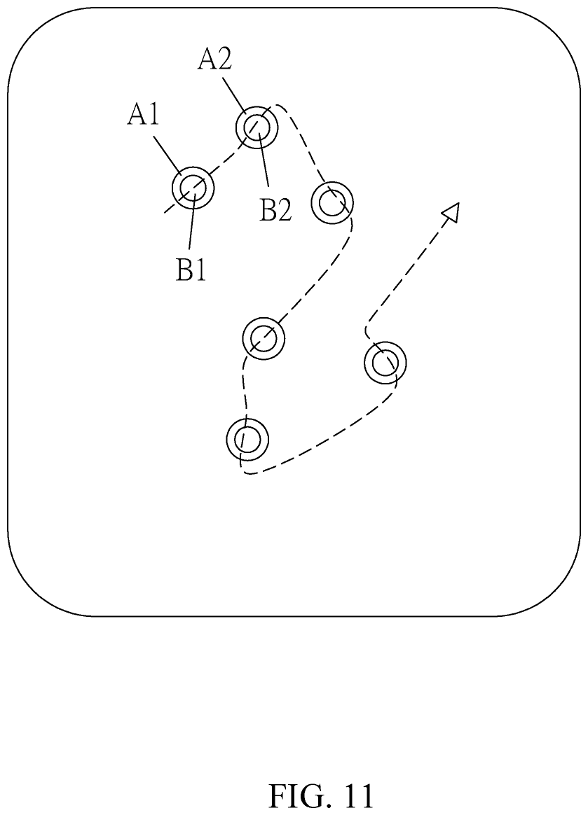

Referring to FIGS. 3 and 11, the computer 30 further comprises an input unit 32, and coordinates of the first drilled hole A1 and the second drilled hole A2 and a moving path of the first moving module 11 can be inputted through the input unit 32.

In the above, the coordinates are the circle center of the first drilled hole A1 and the circle center of the second drilled hole A2, and when the first moving module 11 moves the board A, the moving path is diameter of the first drilled hole A1 and the second drilled hole A2 to allow the first drilled hole A1 and the second drilled hole A2 to pass under the optic probe body 20.

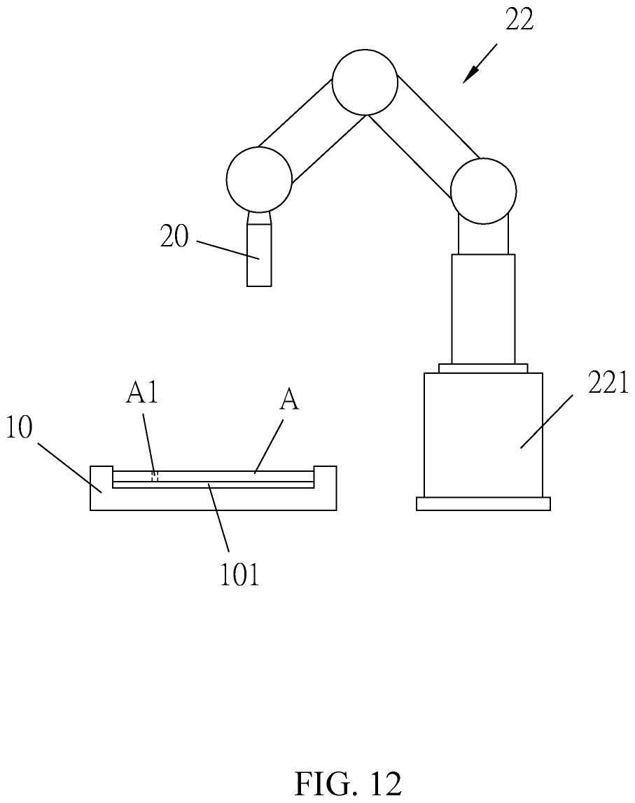

Referring to FIG. 12, a second embodiment of the present invention is provided. The main structure of the instant embodiment is similar to the previous embodiment, and components that are similar between them will be omitted.

In the instant embodiment, the optic probe body 20 is mounted, in a detachable manner, on a second moving module 22. The second moving module 22 is electrically connected with the computer 30, and comprises a second power source 221. The second moving module 22 is arranged above the retaining device 10. When the computer 30 inputs the coordinates of the first drilled hole A1 and the second drilled hole A2 and the moving path, the second power source 221 drives the optic probe body 20 to move, while the retaining device 10 is kept immobile, and in this way, the light beam 21 can also be caused to pass the first drilled hole A1 and the second drilled hole A2 to allow the computer 30 to output the first drilled hole depth plane chart 40 and the second drilled hole depth plane chart 50.

I claim:

1. A non-contact optic probe for enhancing measurement of back drilling profile depth, comprising:
a retaining device, which is connected with a first moving module, the first moving module comprising a first power source, the retaining device comprising a reflection fixture, the reflection fixture having a top surface on which at least one board is positionable, the board being formed with at least one first drilled hole;
at least one optic probe body, which is arranged above the retaining device; and
a computer, which is electrically connected with the optic probe body and the first moving module, the computer comprising an output unit, wherein the computer is operable to activate the optic probe body to emit a light beam, the light beam having a diameter that is smaller than a radius of the first drilled hole, the light beam irradiating the board, and meanwhile, the computer controls the first power source to drive the retaining device to move so as to have the first drilled hole pass under the optic probe body, the first drilled hole being continuously irradiated with the light beam, and the computer records a plurality of first reflection points from entry of the light beam into the first drilled hole and the reflection fixture to exit therefrom, and generates a first drilled hole depth plane chart according to each of the first reflection points, and outputs the first drilled hole depth plane chart by means of the output unit.

2. The non-contact optic probe for enhancing measurement of back drilling profile depth according to claim 1, wherein the board further comprises at least one second drilled hole, and a predetermined distance is formed between the second drilled hole and the first drilled hole, wherein after the first drilled hole passes under the optic probe body, the computer controls the first power source to drive the retaining device to move so as to have the second drilled hole pass under the optic probe body, the second drilled hole being continuously irradiated with the light beam, and the computer records a plurality of second reflection points from entry of the light beam into the second drilled hole and the reflection fixture to exit therefrom, and generates a second drilled hole depth plane chart according to each of the second reflection points, and outputs second drilled hole depth plane chart by means of the output unit.

3. The non-contact optic probe for enhancing measurement of back drilling profile depth according to claim 2, wherein the board comprises at least one first penetration hole and at least one second penetration hole, the first drilled hole and the second drilled hole being respectively drilled in the first penetration hole and the second penetration hole, so that the first drilled hole and the second drilled hole are respectively coincident with and the first penetration hole and the second penetration hole, diameters of the first drilled hole and the second drilled hole being respectively greater than those of the first penetration hole and the second penetration hole; wherein the first drilled hole depth plane chart and the second drilled hole depth plane chart are applicable to inspection of a thickness of the board, depths of the first drilled hole and the second drilled hole, eccentricity of the first drilled hole and the first penetration hole, and eccentricity of the second drilled hole and the second penetration hole, wherein the eccentricity is defined as a distance between a circle center of the first penetration hole and a circle center of the first drilled hole or a distance between a circle center of the second penetration hole and a circle center of the second drilled hole.

4. The non-contact optic probe for enhancing measurement of back drilling profile depth according to claim 2, wherein each of the first reflection points and each of the second reflection points indicate a position where the light beam irradiates a surface of the board, an interior of the first drilled hole, and an interior of the second drilled hole and is blocked to have the light beam reflected back to the optic probe body, and the computer records and calculates the position and distance of each of the first reflection points and the position and distance of each of the second reflection points, and respectively interconnect each of the first reflection points and each of the second reflection points to form the first drilled hole depth plane chart and the second drilled hole depth plane chart.

5. The non-contact optic probe for enhancing measurement of back drilling profile depth according to claim 3, wherein the computer further comprises an input unit, and coordinates of the first drilled hole and the second drilled hole and a moving path of the first moving module are inputted through the input unit.

6. The non-contact optic probe for enhancing measurement of back drilling profile depth according to claim 5, wherein the coordinates are the circle center of the first drilled hole and the circle center of the second drilled hole, and when the first moving module moves the board, the moving path is diameter of the first drilled hole and the second drilled hole to allow the first drilled hole and the second drilled hole to pass under the optic probe body.

7. A non-contact optic probe for enhancing measurement of back drilling profile depth, comprising:
a retaining device, which comprises a reflection fixture, the reflection fixture having a top surface on which at least one board is positionable, the board being formed with at least one first drilled hole;
at least one optic probe body, which is mounted, in a detachable manner, to a second moving module, the second moving module comprising a second power source, the second moving module being arranged above the retaining device; and
a computer, which is electrically connected with the optic probe body and the first moving module, the computer comprising an output unit, wherein the computer is operable to activate the optic probe body to emit a light beam, the light beam a diameter that is smaller than a radius of the first drilled hole, the light beam irradiating the board, and meanwhile the computer controls the second power source to drive the optic probe body to move so as to have the optic probe body pass above the first drilled hole, the first drilled hole being continuously irradiated with the light beam, and the computer records a plurality of first reflection points from entry of the light beam into the first drilled hole and the reflection fixture to exit therefrom, and generates a first drilled hole depth plane chart according to each of the first reflection points, and outputs the first drilled hole depth plane chart by means of the output unit.

8. The non-contact optic probe for enhancing measurement of back drilling profile depth according to claim 7, wherein the board further comprises at least one second drilled hole, and a predetermined distance is formed between the second drilled hole and the first drilled hole, wherein after the optic probe body passes above the first drilled hole, the computer controls the second power source to drive the optic probe body to move so as to have the optic probe body pass above the second drilled hole, the second drilled hole being continuously irradiated with the light beam, and the computer records a plurality of second reflection points from entry of the light beam into the second drilled hole and the reflection fixture to exit therefrom, and generates a second drilled hole depth plane chart according to each of the second reflection points, and outputs second drilled hole depth plane chart by means of the output unit.

9. The non-contact optic probe for enhancing measurement of back drilling profile depth according to claim 8, wherein the board comprises at least one first penetration hole and at least one second penetration hole, the first drilled hole and the second drilled hole being respectively drilled in the first penetration hole and the second penetration hole, so that the first drilled hole and the second drilled hole are respectively coincident with and the first penetration hole and the second penetration hole, diameters of the first drilled hole and the second drilled hole being respectively greater than those of the first penetration hole and the second penetration hole; wherein the first drilled hole depth plane chart and the second drilled hole depth plane chart are applicable to inspection of a thickness of the board, depths of the first drilled hole and the second drilled hole, eccentricity of the first drilled hole and the first penetration hole, and eccentricity of the second drilled hole and the second penetration hole, wherein the eccentricity is defined as a distance between a circle center of the first penetration hole and a circle center of the first drilled hole or a distance between a circle center of the second penetration hole and a circle center of the second drilled hole.

10. The non-contact optic probe for enhancing measurement of back drilling profile depth according to claim 8, wherein each of the first reflection points and each of the second reflection points indicate a position where the light beam irradiates a surface of the board, an interior of the first drilled hole, and an interior of the second drilled hole and is blocked to have the light beam reflected back to the optic probe body, and the computer records and calculates the position and distance of each of the first reflection points and the position and distance of each of the second reflection points, and respectively interconnect each of the first reflection points and each of the second reflection points to form the first drilled hole depth plane chart and the second drilled hole depth plane chart; the computer further comprises an input unit, and coordinates of the first drilled hole and the second drilled hole and a moving path of the first moving module are inputted through the input unit; and the coordinates are the circle center of the first drilled hole and the circle center of the second drilled hole, and when the second moving module moves the optic probe body, the moving path is diameter of the first drilled hole and the second drilled hole to allow the optic probe body to pass above the first drilled hole and the second drilled hole.
